(19) United States
(12) Patent Application Publication
(10) Pub. No.: US 2011/0058307 A1
(43) Pub. Date: Mar. 10, 2011

(54) Chip-type electric double layer capacitor and method for manufacturing the same

(75) Inventors: Sung Ho Lee, Seongnam-si (KR); Seung Hyun Ra, Seongnam-si (KR); Dong Sup Park, Suwon-si (KR); Yeong Su Cho, Guri-si (KR); Sang Kyun Lee, Suwon-si (KR); Hyun Chul Jung, Yongin-si (KR); Chang Ryul Jung, Seoul (KR)

(73) Assignee: SAMSUNG ELECTRO-MECHANICS CO., LTD., Suwon (KR)

(21) Appl. No.: 12/591,410

(22) Filed: Nov. 18, 2009

(30) Foreign Application Priority Data
Sep. 4, 2009 (KR) 10-2009-0083543

(51) Int. Cl. H01G 9/155

(52) U.S. Cl. 361/502; 29/25.03

(57) ABSTRACT

The present invention relates to a chip-type electric double layer capacitor and a method for manufacturing a method for manufacturing the same. The chip-type electric double layer capacitor includes an electric double layer element including two electrodes that include two different polarities and electrode terminals protruded on sides opposite to each other, a first separator that prevents the two electrodes from being short-circuited, and a second separator that is disposed at a position opposed to the first separator on the basis of one electrode of the two electrodes; and a package including package terminals attached to the protruded electrode terminals of the two electrodes, which are formed on the bottom thereof and housing the electric double layer element, wherein the electric double layer element is wound on the basis of the protruded electrode terminals opposite to the two electrodes as a reference axis and the electrode terminals are attached to the package terminals, respectively.

### CROSS-REFERENCE TO RELATED APPLICATIONS

This application claims the benefit of Korean Patent Application No. 10-2009-0083543 filed with the Korea Intellectual Property Office on Sep. 4, 2009, the disclosure of which is incorporated herein by reference.

### BACKGROUND OF THE INVENTION

1. Field of the Invention

The present invention relates to a chip-type electric double layer capacitor and a method for manufacturing the same capable of using a surface-mount technology.

2. Description of the Related Art

A rechargeable battery and an electric double layer capacitor (EDLC) are being widely used to supply a secondary power supply or a main power supply of mobile communication devices and portable electronic products including a notebook computer, etc. which have rapid charge and discharge characteristics of high-density energy.

Since the rechargeable battery has power density lower than the electric double layer capacitor, induces environmental pollution, has short charge/discharge cycles, overcharge, and a risk of exploding at high temperature, a high-performance electric double layer capacitor improving energy density has been recently developed.

The electric double layer capacitor means an electric condenser that accumulates electric energy by using an electrostatic environment generated in the electric double layer formed on an interface between a solid and an electrolyte.

Examples of application fields of the electric double layer capacitor include a system requiring an independent power supply device, a system adjusting instantaneously generated overload, an energy storage device, etc. Recently, a market is being expanded to the application fields.

In particular, a fact that the electric double layer capacitor is superior to the rechargeable battery in energy input/output (power density) is brought out, such that the applicability thereof is being extended as a back-up power supply which is the secondary power supply operating at the time of instantaneous power failure.

Further, since the electric double layer capacitor is superior to the rechargeable battery in charge/discharge efficiency or lifespan, has a relatively wide voltage range, needs not to be maintained, and has an environment-friendly advantage, the electric double layer capacitor is used as a energy source substituting for the rechargeable battery.

The electric double layer capacitor can be classified into a coin type, a cylinder type, and a square type in accordance with an explicit size.

The coin-type electric double layer capacitor has a structure activated carbon electrodes constituted by a pair of sheets are disposed with a separator interposed therebetween and is externally sealed by upper and lower metallic cases and a packing in the state where an electrolyte infiltrates the electrodes. The activated carbon electrodes of the coin-type electric double layer capacitor are in contact with the upper and lower metallic cases by a conductive adhesive. The capacity of the coin-type electric double layer capacitor is 2 F or less and is used as a low-current load.

The square type electric double layer capacitor has an opposed structure in which the separator is interposed between a pair of electrodes acquired by applying an active material onto the surface of an aluminum (Al) collector. In the case of the square-type electric double layer capacitor, since a terminal draw-in/out method is simple, an electrode area is broad, and the thickness of the activated carbon electrode can be thinned, diffusion resistance is small and can be used in a larger capacity than the coin-type electric double layer capacitor. Therefore, the square-type electric double layer capacitor is suitable for a high-current load.

The cylinder-type electric double layer capacitor has a structure in which the pair of electrodes formed by applying the active material onto the surface of the aluminum (Al) collector are wound with the separator interposed therebetween and inserted into an aluminum case by being filtrated with the electrolyte, and thereafter, sealed with rubber.

A lead wire is connected to the aluminum collector and the terminal is drawn out to the outside by the lead wire. The characteristic and use of the cylinder-type electric double layer capacitor are similar to those of the square-type electric double layer capacitor, but in the case of a large-capacity cylinder-type electric double layer capacitor, an output characteristic is reduced due to an increase of contact resistance caused by numerous draw-out electrodes.

As the type of the electric double layer capacitor which is presently produced in mass, the cylinder-type, the coin-type, and the square-type are mainly used. However, it is very difficult to apply the surface-mount technology to this type electric double layer capacitor.

Accordingly, development of a chip-type electric double layer capacitor capable of adopting the surface mount technology (SMT) is required.

### SUMMARY OF THE INVENTION

The present invention has been invented in order to overcome the above-described problem and it is, therefore, an object of the present invention to provide a chip-type electric double layer capacitor joined with an electrode terminal of an electric double layer element by winding a laminated electrode and a separator to increase the capacity of a capacitor and forming a step in a package terminal and a method for manufacturing the chip-type electric double layer capacitor.

In accordance with one aspect of the present invention to achieve the object, there is a chip-type electric double layer capacitor that includes an electric double layer element including two electrodes that include two different polarities and electrode terminals protruded on sides opposite to each other, a first separator that prevents the two electrodes from being short-circuited, and a second separator that is disposed at a position opposed to the first separator on the basis of one electrode of the two electrodes; and a package including package terminals attached to the protruded electrode terminals of the two electrodes, which are formed on the bottom thereof and housing the electric double layer element, wherein the electric double layer element is wound on the basis of the protruded electrode terminals opposite to the two electrodes as a reference axis and the electrode terminals are attached to the package terminals, respectively.

Further, in the chip-type electric double layer capacitor in accordance with the present invention, it is preferable that the second separator is larger than the first separator.

Further, in the chip-type electric double layer capacitor in accordance with the present invention, it is preferable that the size of the first or second separator is larger than those of the two electrodes.

Further, in the wound electric double layer element of the chip-type electric double layer capacitor in accordance with the present invention, it is preferable that any one separator of the first and second separators is interposed at a folded portion of the electrodes in order to prevent the two electrodes from being short-circuited.

Further, in the chip-type electric double layer capacitor in accordance with the present invention, it is preferable that the package terminals formed on the package bottom include steps formed on the package bottom and are attached onto a pair of electrode terminals protruded on the side of the wound electric double layer element.

Further, in the chip-type electric double layer capacitor in accordance with the present invention, it is preferable that the electric double layer element is wound so that the pair of electrode terminals protruded on sides opposite to the two electrodes are disposed on the bottom thereof.

Further, in the chip-type electric double layer capacitor in accordance with the present invention, it is preferable that the electric double layer element is wound in a round shape or a square type.

Further, in the chip-type electric double layer capacitor in accordance with the present invention, it is preferable that the electrode terminal and the package terminal are attached to each other by ultrasonic fusion.

Further, in the chip-type electric double layer capacitor in accordance with the present invention, it is preferable that the first or second separator is made of at least one polymer of polyvinyl alcohol (PVA), polyvinylidene fluoride (PVDF), polypropylene (PP), a teflon resin, a silicon resin, a modified silicon, and styrene-butyl rubber (SBR).

Further, in the chip-type electric double layer capacitor in accordance with the present invention, it is preferable that the length of the package terminal attached to the electrode terminal is equal to or larger than the length of the electrode terminal.

Further, in the chip-type electric double layer capacitor in accordance with the present invention, it is preferable that the two electrodes and electrode terminals have the same size and shape as each other.

Further, in the chip-type electric double layer capacitor in accordance with the present invention, it is preferable that the length of the electrode terminal is 20 μm.

In accordance with another aspect of the present invention to achieve the object, there is provided a method for manufacturing a chip-type electric double layer capacitor that includes forming an electric double layer element including two electrodes that include two different polarities and electrode terminals protruded on sides opposite to each other, a first separator that prevents the two electrodes from being short-circuited, and a second separator that is disposed at a position opposed to the first separator on the basis of one electrode of the two electrodes; winding the electric double layer element on the basis of a pair of electrode terminals protruded on sides opposite to the two electrodes as a reference axis; housing the electric double layer element in a package including a package terminal provided on the bottom thereof; disposing a pair of electrode terminals protruded on sides opposite to the two electrodes of the wound electric double layer element to be attached to the package terminal; and attaching the package terminals to a pair of electrode terminals by ultrasonic fusion.

Further, in the method for manufacturing a chip-type electric double layer capacitor in accordance with the present invention, it is preferable that forming the electric double layer element includes disposing the second separator; disposing a first electrode that is disposed on the second separator and includes one electrode terminal protruded on one side; disposing the first separator on the first electrode; and disposing a second electrode that includes a polarity different from the first electrode on the first separator and one electrode terminal protruded on a side opposite to an electrode terminal of the first electrode.

Further, in the method for manufacturing a chip-type electric double layer capacitor in accordance with the present invention, it is preferable that the second separator is larger than the first separator.

Further, in the method for manufacturing a chip-type electric double layer capacitor, in accordance with the present invention, it is preferable that housing the electric double layer in a package including the package terminal provided on the bottom thereof includes forming a package bottom housing the electric double layer element; and attaching the package terminal to a pair of electrode terminals protruded on the side of the wound electric double layer element while a step is formed on the package bottom.

Further, in the method for manufacturing a chip-type electric double layer capacitor in accordance with the present invention, it is preferable that in winding the electric double layer element on the basis of the pair of electrode terminals protruded on sides opposite to the two electrodes as a reference axis, any one separator of the first and second separators is interposed at a folded portion of the electrodes in order to prevent the two electrodes from being short-circuited.

Further, in the method for manufacturing a chip-type electric double layer capacitor in accordance with the present invention, it is preferable that the length of the electrode terminal is 20 μm.

Further, in the method for manufacturing a chip-type electric double layer capacitor in accordance with the present invention, it is preferable that in attaching the package terminal to a pair of electrode terminals by ultrasonic fusion, a molecular combination is generated with friction heat generated by converting electric energy supplied as electric power into mechanical energy, such that the electrode terminal and the package terminal are melted and attached to each other.

Further, it is preferable that the method for manufacturing a chip-type electric double layer capacitor in accordance with the present invention further includes charging the inner part of the package with an electrolyte.

In accordance with an embodiment of the present invention, it is possible to apply a surface mount technology (SMT) by providing a chip-type electric double layer capacitor and it is possible to increase the capacity by alternately laminating and winding an electrode and a separator to form an electric double layer element.

Further, since a package terminal is attached to an electrode terminal of the electric double layer element by forming the package terminal to have a step from the bottom there, the electrode terminal of the electric double layer element can stably be attached to the package terminal at the time of attaching the electrode terminal and the package terminal to each other by using ultrasonic fusion.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view of an electric double layer element of a chip-type electric double layer capacitor in accordance with an embodiment of the present invention;

FIG. 2 is a cross-sectional view of a lamination structure of an electric double layer element of a chip-type electric double layer capacitor in accordance with an embodiment of the present invention;

FIGS. 3A to 3C are diagrams showing the shape of a wound electric double layer element of a chip-type electric double layer capacitor in accordance with an embodiment of the present invention;

FIG. 4 is a cross-sectional view of a package bottom of a chip-type electric double layer capacitor in accordance with an embodiment of the present invention;

FIG. 5 is a cross-sectional view of a chip-type electric double layer capacitor in accordance with an embodiment of the present invention; and

FIGS. 6A to 6E are flowcharts of a method for manufacturing a chip-type electric double layer capacitor in accordance with an embodiment of the present invention.

### DETAILED DESCRIPTION OF THE PREFERABLE EMBODIMENTS

A matter regarding to a configuration and an effect of the present invention will be appreciated clearly through the following detailed description with reference to the accompanying drawings illustrating preferable embodiments of the present invention. Hereinafter, an embodiment in accordance with the present invention will be described in detail with reference to the accompanying drawings.

Hereinafter, a chip-type electric double layer capacitor (EDLC) and a method for manufacturing the chip-type EDLC will be described in detail with reference to the accompanying drawings. Like elements refer to like reference numerals and a repeated description thereof will be omitted.

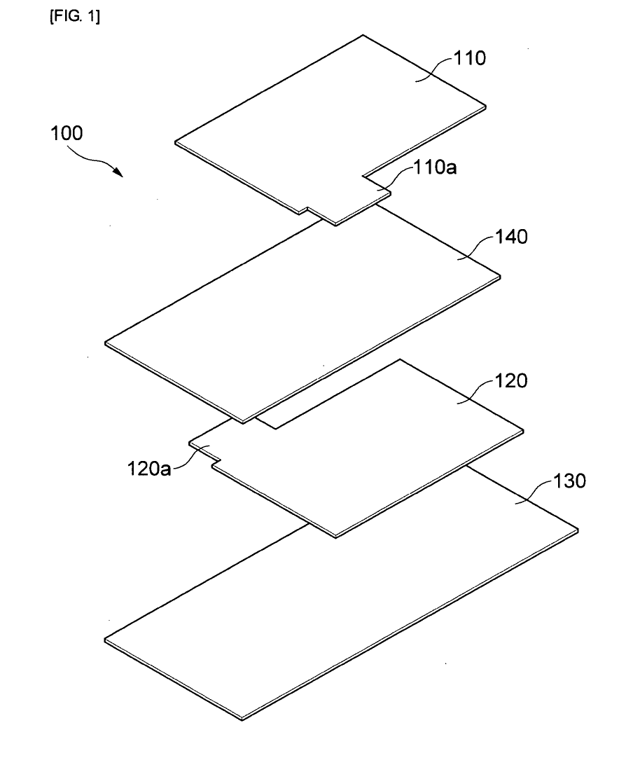

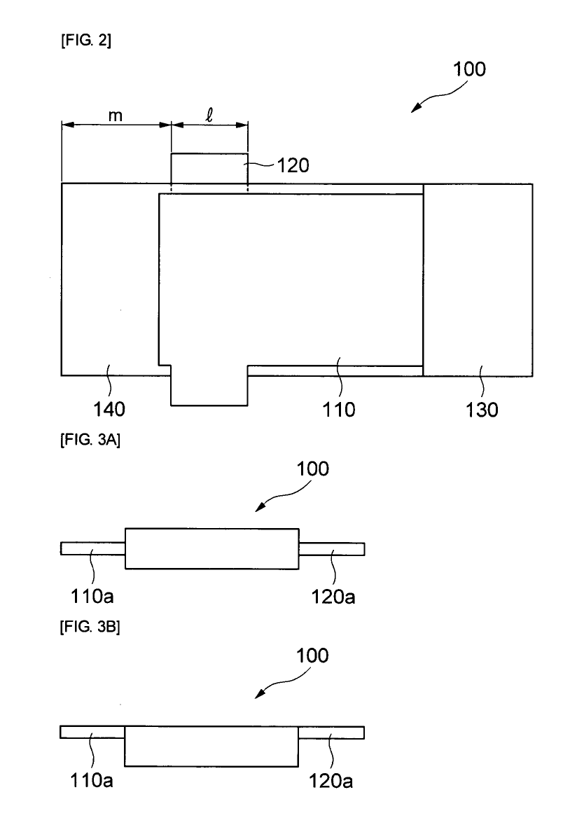

FIGS. 1 and 2 are cross-sectional views of an electric double layer element of a chip-type electric double layer capacitor and a lamination structure thereof in accordance with an embodiment of the present invention.

The chip-type electric double layer capacitor in accordance with the embodiment of the present invention includes an electric double layer element 100 and a package 200.

As shown in FIGS. 1 and 2, the electric double layer element 100 of the chip-type electric double layer capacitor includes two electrodes 110 and 120 having different polarities, a first separator 140, and a second separator 130.

The two electrodes 110 and 120 have different polarities and include electrode terminals 110a and 120a that protrude at sides opposite to each other, respectively. A pair of electrode terminals 110a and 120a that protrude are attached to be electrically connected to a lower package terminal by heat or ultrasonic waves.

The two electrodes 110 and 120 include the electrode terminals 110a and 120a at the sides opposite to each other. The two electrodes 110 and 120 and two electrode terminals 110a and 120 have the same size and shape as each other or sizes and shapes corresponding to each other.

The electrode terminals 110a and 120a may have various shapes and preferably, have a rectangular shape and a shape corresponding to the shape of the package terminal.

The length of the electrode terminal may be approximately 20 μm and may be adjusted depending on the shape of the electrode terminal and the shape of the package terminal.

The first separator 140 is interposed between the two electrodes 110 and 120 so as to prevent the two electrodes 110 and 120 from being short-circuited and the second separator 130 is disposed at a position opposed to the first separator 140 on the basis of any one electrode of the two electrodes 110 and 120, the electric double layer element 100 is wound so as to prevent the two electrodes 110 and 120 from being short-circuited.

For example, the second separator 130 is disposed and one electrode 120 is laminated on the second separator 130, and the other electrode 110 is laminated after the first separator 140 is laminated on the electrode, such that the electric double layer element 100 can be formed.

The second separator 130 is larger than the first separator 140 and the size of the first separator 130 or the second separator 140 is preferably larger than the sizes of the two electrodes 110 and 120.

The first separator 130 or the second separator 140 may be made of at least one polymer of polyvinyl alcohol (PVA), polyvinylidene fluoride (PVDF), polypropylene (PP), a Teflon resin, a silicon resin, a modified silicon, and styrene-butyl rubber (SBR).

As shown in FIG. 2, in the electric double layer element 100 of the chip-type electric double layer capacitor, the electrode terminal may be disposed at a position m separated from one side of the second separator 130 by the length I of the electrode terminal.

The lamination structure is one example a lamination structure in which after the electric double layer element 100 wound, any one of the first and second separators is interposed at a folded portion of the electrodes in order to prevent the electrodes laminated on the top from being short-circuited.

The electric double layer element 100 is wound on the basis of the electrode terminals 110a and 120a that protrude at the opposite sides of the two electrodes 110 and 120 as a reference axis to thereby have a round shape, a square shape, or the like.

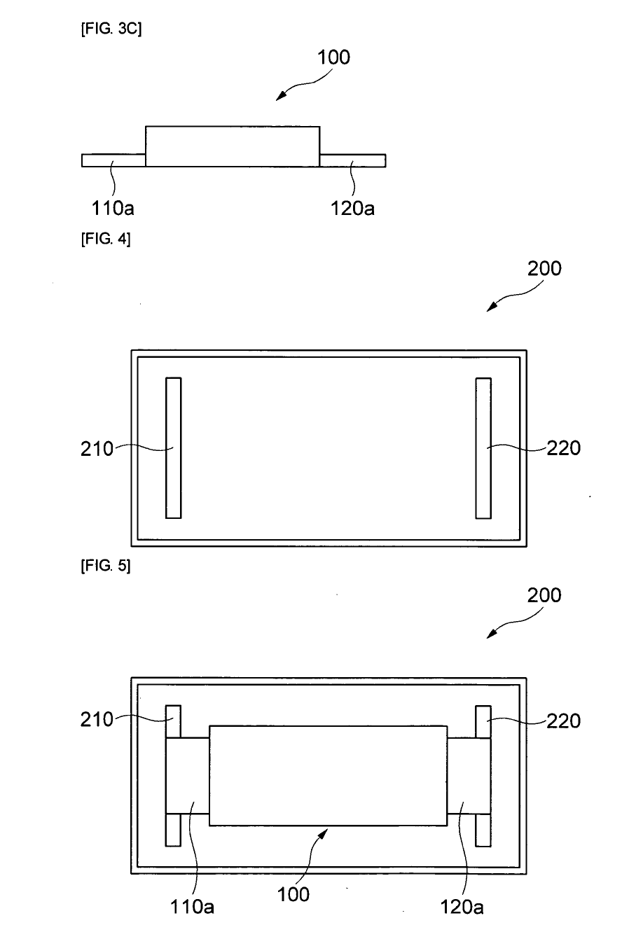

FIGS. 3A to 3C are diagrams showing the shape of a wound electric double layer element of a chip-type electric double layer capacitor in accordance with an embodiment of the present invention.

As shown in FIGS. 3A to 3C, the shape of the wound electric double layer element 100 of he chip-type electric double layer capacitor in accordance with the embodiment of the present invention may have the round shape, the square shape, or the like, and the electrode terminals 110a and 120a protrude on both sides of the electric double layer element 100.

Depending on a winding method of the electric double layer element 100, the electrode terminals 110a and 120a may be disposed on the central axis of the wound electric double layer element 100 (see FIG. 3A) or at one side of the wound electric double layer element 100 (see FIGS. 3B and 3C).

When a step of a lower package terminal can be determined to correspond to the positions of the electrode terminals 110a and 120a after the electric double layer element 100 is wound, while the electric double layer element 100 may be wound so as to attach the electrode terminals 110a and 120a to the lower package terminal.

FIG. 4 is a cross-sectional view of a package bottom of a chip-type electric double layer capacitor in accordance with an embodiment of the present invention and FIG. 5 is a cross-sectional view of a chip-type electric double layer capacitor in accordance with an embodiment of the present invention.

As shown in FIG. 4, the package 200 of the chip-type electric double layer capacitor in accordance with the embodiment of the present invention includes package terminals 210 and 220 formed on the bottom thereof and houses the electric double layer element 100.

The package 200 is constituted by a lower package including the package terminals 210 and 220 formed inside of the bottom thereof and an upper package covering the lower package. The upper and lower packages are sealed so as not to expose internal elements to be housed to the outside.

The package terminals 210 and 220 formed on the bottom of the package 200 are attached to the pair of the electrode terminals 110 and 120a after a step is formed from the bottom of the package 200 and the electric double layer element 100 is wound.

For example, when the steps of the package terminals 210 and 220 are low, the electric double layer element 100 is wound so that the electrode terminals 110a and 120a which protrude on the opposite surface of the two electrodes 110 and 120 are disposed on the bottom and when the steps of the package terminals 210 and 220 are high, the protruding electrode terminals 110a and 120a may be wound to be disposed on the central axis or the top of the electric double layer element 100.

The package terminals 210 and 220 on the bottom of the package 200 are attached to the pair of the protruded electrode terminals 110 and 120a of the two electrodes 110 and 120. Further, the package terminals 210 and 220 may be attached to the protruded electrode terminals 110a and 120a by ultrasonic fusion.

The ultrasonic fusion represents a molecular combination in which melting and attachment are made by using friction heat generated while electric power having a frequency of approximately 50 to 60 Hz is converted into electric energy of 15 to 20 kHz by using an oscillator power voltage and thereafter, converted into mechanical energy through a converter and a booster.

Therefore, attachment should be made so as to prevent the electrode terminal and the package terminal from being detached from each other due to strong vibration generated during the ultrasonic fusion.

The package terminals 210 and 220 can be electrically connected to the electric double layer element 100 through the fused electrode terminals 110a and 120a.

The lengths of the package terminals 210 and 220 may be equal to or larger than the length l of the protruded electrode terminals 110a and 120a and the package terminals 210 and 220 may have shapes corresponding to shapes of the protruded electrode terminals 110a and 120a.

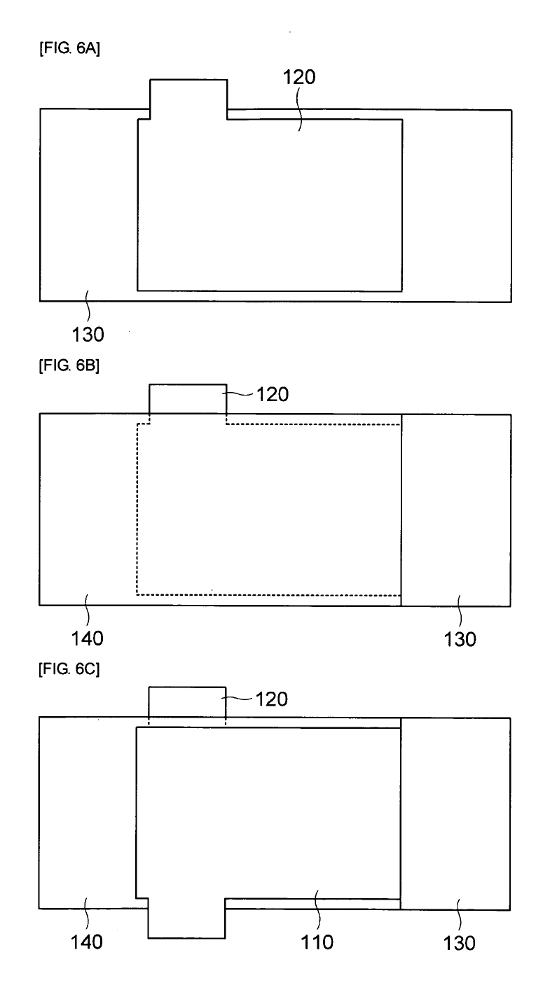

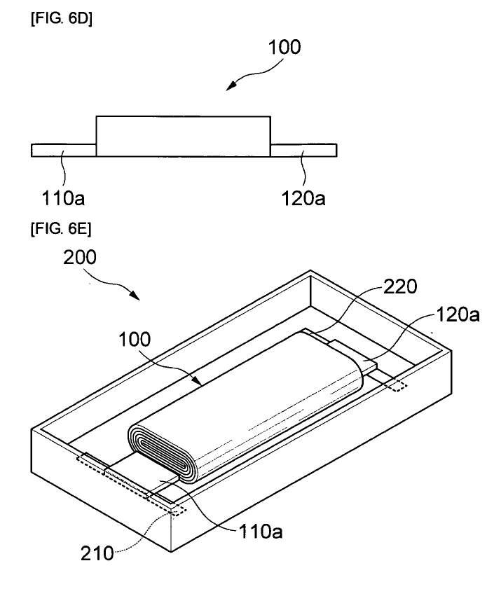

FIGS. 6A to 6E are flowcharts of a method for manufacturing a chip-type electric double layer capacitor in accordance with an embodiment of the present invention.

As shown in FIGS. 6A to 6E, the method for manufacturing a chip-type electric double layer capacitor in accordance with the embodiment of the present invention includes forming an electric double layer element 100 (see FIGS. 6A to 6C) and winding the electric double layer element 100 in a square shape, a round shape, or the like on the basis of electrode terminals 110a and 120a that protrude on opposite sides to two electrodes as a reference axis.

Next, package terminals 210 and 220 are formed on the bottom and a package 200 packaging the electric double layer element 100 is formed. Thereafter, the electrode terminals 110a and 120a that protrude on the opposite sides to the two electrodes of the wound electric double layer element 100 are attached to the package terminals 210 and 220.

Next, it is possible to manufacture the chip-type electric double layer capacitor by attaching the package terminals 210 and 220 to the protruded electrode terminals 110a and 120a of two electrodes attached to each other by using ultrasonic fusion.

In a method for forming the electric double layer element 100, a second separator 130 is first disposed and a first electrode 120 including one protruded electrode terminal formed on at one side thereof is disposed in the second separator 130.

Next, a first separator 140 is disposed in the first electrode 120 and a second electrode 110 having a polarity different from the polarity of the first electrode and including one protruded electrode terminal formed on the opposite side to the electrode terminal of the first electrode 120 is disposed in the first separator 140 to thereby form the electric double layer element 100.

The second separator 130 may be larger than the first separator 140 in size. Each electrode may be disposed at a position separated from one side of the second separator 130 by the length of the electrode terminal or more.

Further, the length l of the electrode terminal may be approximately 20 μm. Sizes and shapes of two electrodes and two electrode terminals may be the same as or correspond to each other.

In a method for forming the package 200 housing the electric double layer element 100, a package bottom for housing the electric double layer element 100 is formed and the package terminals 210 and 220 attached to the electrode terminal with a step that protrudes from the package bottom is formed.

A method for attaching the protruded electrode terminal and the package terminal to each other by using the ultrasonic fusion may use a method in which a molecular combination is generated with friction heat generated by converting electric energy supplied as electric power into mechanical energy, such that the electrode terminal and the package terminal are melted and attached to each other.

In the chip-type electric double layer capacitor in accordance with the embodiment of the present invention, the package terminals 210 and 220 has uniform steps from the package bottom to be stably attached to the electrode terminals 110a and 120a of the wound electric double layer element 100 and the package terminal of the package bottom may be mounted on the surface of the substrate while being exposed to the outside of the package.

Further, the inner part of a lower package with the package terminal is charged with an electrolyte and sealed with an upper package to form the chip-type electric double layer capacitor.

As described above, although the preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

1. A chip-type electric double layer capacitor, comprising:
an electric double layer element including two electrodes that include two different polarities and electrode terminals protruded on sides opposite to each other, a first separator that prevents the two electrodes from being short-circuited, and a second separator that is disposed at a position opposed to the first separator on the basis of one electrode of the two electrodes; and
a package including package terminals attached to the protruded electrode terminals of the two electrodes, which are formed on the bottom thereof and housing the electric double layer element,
wherein the electric double layer element is wound on the basis of the protruded electrode terminals opposite to the two electrodes as a reference axis and the electrode terminals are attached to the package terminals, respectively.

2. The chip-type electric double layer capacitor in accordance with claim 1, wherein the second separator is larger than the first separator.

3. The chip-type electric double layer capacitor in accordance with claim 1, wherein the size of the first or second separator is larger than those of the two electrodes.

4. The chip-type electric double layer capacitor in accordance with claim 1, wherein in the wound electric double layer element, any one separator of the first and second separators is interposed at a folded portion of the electrodes in order to prevent the two electrodes from being short-circuited.

5. The chip-type electric double layer capacitor in accordance with claim 1, wherein the package terminals formed on the package bottom include steps formed on the package bottom and are attached onto a pair of electrode terminals protruded on the side of the wound electric double layer element.

6. The chip-type electric double layer capacitor in accordance with claim 1, wherein the electric double layer element is wound so that the pair of electrode terminals protruded on sides opposite to the two electrodes are disposed on the bottom thereof.

7. The chip-type electric double layer capacitor in accordance with claim 1, wherein the electric double layer element is wound in a round shape or a square type.

8. The chip-type electric double layer capacitor in accordance with claim 1, wherein the electrode terminal and the package terminal are attached to each other by ultrasonic fusion.

9. The chip-type electric double layer capacitor in accordance with claim 1, wherein the first or second separator is made of at least one polymer of polyvinyl alcohol (PVA), polyvinylidene fluoride (PVDF), polypropylene (PP), a teflon resin, a silicon resin, a modified silicon, and styrene-butyl rubber (SBR).

10. The chip-type electric double layer capacitor in accordance with claim 1, wherein the length of the package terminal attached to the electrode terminal is equal to or larger than the length of the electrode terminal.

11. The chip-type electric double layer capacitor in accordance with claim 1, wherein the two electrodes and electrode terminals have the same size and shape as each other.

12. The chip-type electric double layer capacitor in accordance with claim 1, wherein the length of the electrode terminal is 20 μm.

13. A method for manufacturing a chip-type electric double layer capacitor, comprising:
forming an electric double layer element including two electrodes that include two different polarities and electrode terminals protruded on sides opposite to each other, a first separator that prevents the two electrodes from being short-circuited, and a second separator that is disposed at a position opposed to the first separator on the basis of one electrode of the two electrodes;
winding the electric double layer element on the basis of a pair of electrode terminals protruded on sides opposite to the two electrodes as a reference axis;
housing the electric double layer element in a package including a package terminal provided on the bottom thereof;
disposing a pair of electrode terminals protruded on sides opposite to the two electrodes of the wound electric double layer element to be attached to the package terminal; and
attaching the package terminals to a pair of electrode terminals by ultrasonic fusion.

14. The method for manufacturing a chip-type electric double layer capacitor in accordance with claim 13, wherein forming the electric double layer element includes:
disposing the second separator;
disposing a first electrode that is disposed on the second separator and includes one electrode terminal protruded on one side;
disposing the first separator on the first electrode; and
disposing a second electrode that includes a polarity different from the first electrode on the first separator and one electrode terminal protruded on a side opposite to an electrode terminal of the first electrode.

15. The method for manufacturing a chip-type electric double layer capacitor in accordance with claim 13, wherein the second separator is larger than the first separator.

16. The method for a chip-type electric double layer capacitor in accordance with claim 13, wherein housing the electric double layer in a package including the package terminal provided on the bottom thereof includes:
forming a package bottom housing the electric double layer element; and
attaching the package terminal to a pair of electrode terminals protruded on the side of the wound electric double layer element while a step is formed on the package bottom.

17. The method for manufacturing a chip-type electric double layer capacitor in accordance with claim 13, wherein in winding the electric double layer element on the basis of the pair of electrode terminals protruded on sides opposite to the two electrodes as a reference axis, any one separator of the first and second separators is interposed at a folded portion of the electrodes in order to prevent the two electrodes from being short-circuited.

18. The method for manufacturing a chip-type electric double layer capacitor in accordance with claim 13, wherein in forming the electric double layer element, the length of the electrode terminal is 20 μm.

19. The method for manufacturing a chip-type electric double layer capacitor in accordance with claim 13, wherein in attaching the package terminal to a pair of electrode terminals by ultrasonic fusion, a molecular combination is generated with friction heat generated by converting electric energy supplied as electric power into mechanical energy, such that the electrode terminal and the package terminal are melted and attached to each other.

20. The method for manufacturing a chip-type electric double layer capacitor in accordance with claim 13, further comprising:
charging the inner part of the package with an electrolyte.
